(19) United States
(12) Patent Application Publication
(10) Pub. No.: US 2008/0281959 A1
(43) Pub. Date: Nov. 13, 2008

(54) MANAGING ADDITION AND REMOVAL OF NODES IN A NETWORK

(76) Inventor: ALAN ROBERTSON, Broomfield, CO (US)

Correspondence Address: CENTURY IP GROUP, INC. [Main], P.O. BOX 7333, NEWPORT BEACH, CA, 92658-7333, US

(21) Appl. No.: 11/747,174

(22) Filed: May 10, 2007

(51) Int. Cl. G06F 15/16

(52) U.S. Cl. 709/224

(57) ABSTRACT

Systems and methods for managing a networked computing environment. The method comprising determining a change in status of a first computing system in a network according to status information communicated from the first computing system to a monitor system over a dedicated connection formed between the first computing system and the monitor system, wherein the dedicated connection is independent of network communication lines connecting the first computing system to other computing systems in the network.

### COPYRIGHT & TRADEMARK NOTICES

A portion of the disclosure of this patent document contains material which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### FIELD OF INVENTION

The present invention relates generally to managing a plurality of computing systems in a clustered environment and, more particularly, to a system and method for managing the connection and removal of one or more computing systems in a clustered network.

### BACKGROUND

A cluster is, typically, a parallel or distributed network environment consisting of a collection of interconnected computers. A cluster is implemented such that the plurality of computers in the cluster can be collectively used as a single, unified computing resource. Thus, a cluster is represented as a single system even though it is made up of a network of multiple individual computers. The individual computers are commonly known as cluster nodes or nodes.

The IBM BladeCenter® is an exemplary system that physically consolidates the plurality of computers in a cluster into a common chassis. The BladeCenter chassis, for example, supports up to 14 computers (e.g., server blades) interconnected with one or two Ethernet network switches. Each computer is represented as a node in the cluster and has up to four high-speed network interfaces. Each interface is connected to a switch module bay in such a way that the 14 nodes have point-to-point connections to each of the integrated network switch module bays.

Information about the status of each computer in the cluster and whether it is currently a member of the cluster is maintained by a cluster controller. The cluster controller is unable, however, to dynamically manage the removal of a node from the configuration of the network, when a computer corresponding to the node is removed from the cluster. Since certain types of network failures are indistinguishable from the node being powered off or having failed as a whole, if a computer is powered off or disconnected from the network, a manual procedure will have to be performed to remove the corresponding node from the cluster configuration.

Unfortunately, such manual methods are burdensome for system managers and also fail to provide a robust operational environment. Furthermore, when an operation is dependent on the participation of a minimum number of nodes (i.e., quorum), the unavailability of a node can have undesirable consequences. For example, if a computer in the cluster becomes unavailable, such that the quorum requirement is not met, the entire clustered system may have to be shutdown until the reason for the unavailability of the computer is determined. Such events are undesirable and costly, especially where the continuous and robust operation of clustered systems is essential to the success of enterprises that employ them.

Methods and systems are needed that can overcome the above shortcomings.

### SUMMARY

The present disclosure is directed to a system and corresponding methods that facilitate the automatic management of nodes in a cluster.

In accordance with one embodiment, systems and methods for managing a networked computing environment are provided. The method comprises determining a change in status of a first computing system in a network according to status information communicated from the first computing system to a monitor system over a dedicated connection formed between the first computing system and the monitor system, wherein the dedicated connection is independent of network communication lines connecting the first computing system to other computing systems in the network.

In accordance with another embodiment, a computer program product comprising a computer useable medium having a computer readable program is provided. The computer readable program when executed on a computer causes the computer to perform the above-disclosed actions to manage one or more nodes in a clustered environment.

### BRIEF DESCRIPTION OF THE DRAWINGS

Embodiments of the present invention are understood by referring to the figures in the attached drawings, as provided below.

FIG. 1 illustrates a network environment, wherein a plurality of computing systems are interconnected, in accordance with one embodiment.

FIG. 2 illustrates a block diagram of an exemplary network environment wherein one or more computing systems in a network are connected to a monitor system by way of a dedicated connection, in accordance with one embodiment.

FIG. 3 illustrates a flow diagram of a method of managing a plurality of nodes in a network, in accordance with one embodiment.

FIGS. 4A and 4B are block diagrams of hardware and software environments in which a system of the present invention may operate, in accordance with one or more embodiments.

Numeral references do not connote a particular order of performance, hierarchy or importance, unless otherwise stated herein. Features, elements, and aspects of the invention that are referenced by the same numerals in different figures represent the same, equivalent, or similar features, elements or aspects, in accordance with one or more embodiments.

### DETAILED DESCRIPTION OF EXEMPLARY EMBODIMENTS

The present disclosure is directed to systems and corresponding methods that facilitate managing a plurality of interconnected computing systems in a network. In one embodiment, a node monitor has a dedicated connection to one or more of the plurality of computing systems in the network, such that the node monitor can reliably determine the operational status of each computing system to the network, preferably, in real-time.

If one or more computing systems cannot communicate with a target computing system in the network, the operational status of a target computing system can be determined based on information communicated from the target computing system to the node monitor. The node monitor may be connected to the target computing system by way of a dedicated connection. If the information available to the node monitor indicates that the target computing system is disabled (e.g., turned off), then a node that logically represents the target computing system is removed from the cluster configuration, automatically and without requiring human intervention.

In the following, numerous specific details are set forth to provide a thorough description of various embodiments of the invention. Certain embodiments may be practiced without these specific details or with some variations in detail. In some instances, certain features are described in less detail so as not to obscure other aspects of the invention. The level of detail associated with each of the elements or features should not be construed to qualify the novelty or importance of one feature over the others.

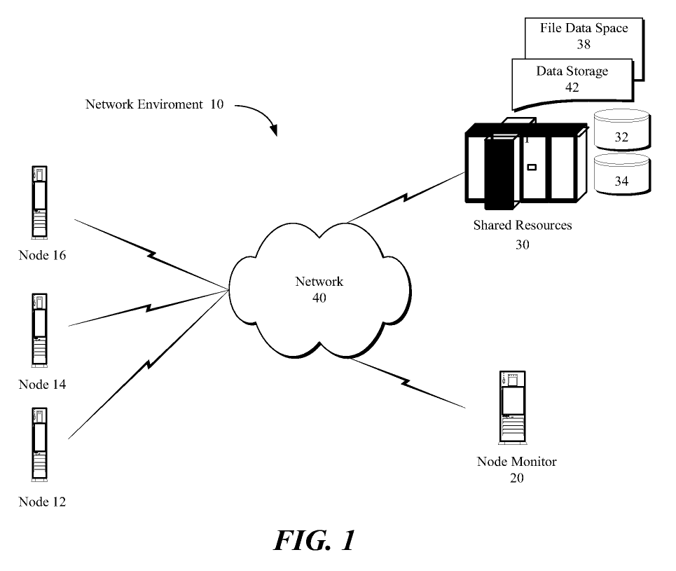

Referring to FIG. 1, a network environment 10 (e.g., a clustered network) is illustrated. Network environment 10, in accordance with one embodiment, comprises a node monitor 20 connected to a plurality of computing systems in a network 40. Each computing system is logically represented as a node (e.g., nodes 12, 14 and 16) in the network 40.

Node monitor 20 may be connected to each computing system over a dedicated line to monitor the operational status of each node. That is, for example, if a computing system is turned on/off, or otherwise enabled/disabled, the change in the computing system's status may be detected by node monitor 20 in real-time.

Network 40 may be implemented as a distributed network in one embodiment. In other embodiments, network 40 may be implemented to connect the plurality of nodes in parallel, serial, or a combination thereof. Any networking protocol that allows the nodes to be utilized as a single unified cluster of computing resources may be used to implement the physical and logical infrastructure of network 40.

Node monitor 20 (or other monitoring system) may be configured to examine the status of each node in network 40, so that a change in status of each node can be reliably detected by node monitor 20. As such, the node monitor has the capability to reliably and independently examine the operational status of each node in network 40.

Status information about each node may include information about whether a computing system represented by a node is available or unavailable (i.e., enable or disabled). Depending on the operational environment, node monitor 20 may determine the availability or unavailability of a node by monitoring various operational factors.

For example, in a distributed network, node monitor 20 may determine that a computing system is available, if the computing system is turned on. In a consolidated network environment (e.g., IBM BladeCenter), node monitor 20 may determine that a computing system is available, if the computing system is connected to a central chassis, for example.

In an environment with a virtual machine, a computing system may be deemed available if the virtual machine indicates that the computing system is operational. Similarly, depending on the operating environment, node monitor 20 may determine that a computing system is unavailable if it is determined that the computing system is turned off, or has otherwise become disabled.

In certain embodiments, one or more nodes in the cluster are assigned to perform a common task or are connected to shared resources 30 by way of network 40 and possibly other networks (e.g., storage networks). Shared resources 30 may comprise a plurality of devices such as shared disks 32 and 34 that, for example, contain blocks of data for files managed by a distributed file system. In some embodiments, shared resources 30 comprise at least one of a hard disk drive, a tape drive, an optical disk drive, a floppy drive, flash memory, other types of data storage medium, or a combination thereof.

Shared resources 30 may also comprise data storage 42 and file data space 38, so that each node in the cluster can access data stored in data storage 42, or an object stored on file data space 38. In certain embodiments, the individual nodes in the cluster may not have direct access to shared resources 30 and thus may communicate with a server system (not shown) in network 40 to access data or services available at shared resources 30.

For example, to access a file available on shared resources 30, node 12 may contact a server system to obtain object metatdata and locks needed to access the content of the file. The metadata provides information about a file, such as file attributes and storage location. Locks provide information about privileges needed to open a file and read or write data.

In one embodiment, the server system communicates the needed lock information to node 12 in addition to the addresses of all data blocks making up the requested file. The server system may be one of a virtual server implemented as a part of the cluster or another computing system in network 40.

Once node 12 holds a lock on the file and knows the data block address, plurality of nodes in network environment 10 can be utilized as a singular and unified computer resource. In certain embodiments, more than one node may have authorization to access a shared resource. Therefore, to avoid deadlock or corruption of resources, each node in the cluster functions in accord with the other nodes by determining the status and preferably operations assigned to each node.

For example, where nodes 12 and 14 are writing to a common file, if node 12 is unable to communicate with node 14 due to a loss in network communication or node 14's malfunction, the write operation may be discontinued until the reason for the loss of communication can be determined. Otherwise, if the two nodes attempt to write to the same file at the same time, the file may be corrupted or a deadlock may occur.

To avoid any unintended results or discontinuation in operation of nodes in the cluster, in certain embodiments, a quorum requirement is enforced. Where N represents the number of nodes in the cluster, a minimum number of nodes (e.g., (N+1)/2) are to take part in performance of a task to satisfy the quorum requirement. Accordingly, unless the number of active nodes responsible for performing the task falls below a certain threshold, the cluster continues to operate, even if one or more nodes become inactive while the operation is being performed.

In one embodiment, the quorum requirements are implemented to intervene when one or more nodes can no longer communicate. Preferably, each node within the cluster can communicate with other nodes in the cluster via network 40. If the network connection between two or more nodes fails, the cluster is split into at least two partitions. Each partition includes one or more active nodes that cannot communicate with the nodes in the other partition, due to the loss in network connection.

In such a situation, the active nodes in the two partitions that cannot continue to operate to perform a shared task, as noted earlier, may have to be shutdown to avoid undesirable consequences. In one embodiment, to avoid a forced shutdown of the entire cluster, the responsibility for performing a shared task is assigned to one of the two partitions that best satisfies the quorum requirement.

For example, in an IBM BladeCenter that supports 14 nodes, a first partition including nine nodes may satisfy the quorum requirement over a second partition that includes five nodes. Once the nodes in the selected partition take over the operation, the nodes in the unselected partition are removed from the cluster to avoid any conflicts.

One or more exemplary embodiments are provided below in more detail with reference to FIGS. 1 through 3. It is noteworthy, however, that the disclosed elements in network environment 10, as illustrated in FIGS. 1 through 3, are exemplary in nature. Network environment 10 in addition to node monitor 20, nodes 12, 14, 16 and shared resources 30 may include additional or fewer elements, without detracting from the scope of the invention or the principals disclosed herein.

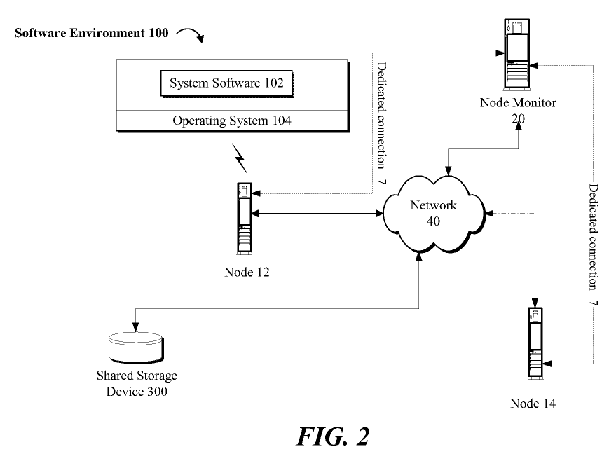

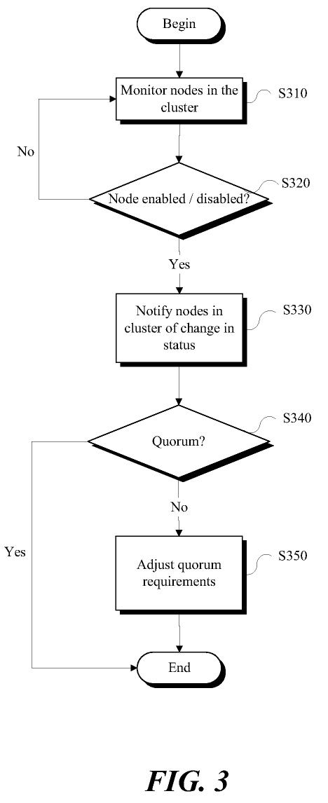

Referring to FIGS. 2 and 3, a node monitor 20 in accordance with one embodiment is implemented to monitor the status of a plurality of nodes in network 40 (S310). If the operational status of a computing system represented by a node in the cluster changes, node monitor 20 notifies the other nodes of the change. This may be done in real-time. In an alternative embodiment, the status of each node is recorded and updated in a status database created by the node monitor 20. In such embodiment, each node may access the status database to determine the change in status of each node.

In one embodiment, node monitor 20 monitors the status of the computing systems in network 40 to determine if a computing system, for example represented by node 14, is enabled or disabled (S320). In an exemplary embodiment, node monitor 20 may examine the status of computing systems associated with nodes 12 and 14 by way of a dedicated connection 7 which may be independent from network 40. Accordingly the status of each node may be monitored regardless of whether a node is physically or logically connected to network 40.

In response to node monitor 20 determining that a computing device represented by node 14 has been enabled or disabled, the node monitor 20 notifies one or more other nodes (e.g., node 12) of the change in status of node 14 (S330). As provided in further detail below, once the change in status of a computing system is detected, further action is taken to add or remove the corresponding node from the cluster, without human intervention.

As shown in FIG. 2, an exemplary software environment 100 is illustrated, wherein system software 102 is executed on top of an operating system 104. For the purpose of example, system software 102 is illustrated as running on a computing system represented by node 12. It should be noted, however, that system software 102 may run on another computing system or a combination of computing systems that are either locally or remotely connected to network 40.

System software 102 may be configured to manage and update cluster configuration for one or more nodes in the exemplary clustered network illustrated in FIG. 2. In this exemplary embodiment, system software 102 removes node 14 from cluster configuration of node 12, in response to node monitor 20 reporting that the computing system logically represented by node 14 has been disabled.

Alternatively, system software 102 adds node 14 to cluster configuration of node 12, in response to node monitor 20 reporting that the computing system logically represented by node 14 has been enabled. In this manner, system software 102 automatically handles the addition and removal of nodes from the cluster based on information provided by node monitor 20, without the need for human intervention.

In another exemplary embodiment, nodes 12 and 14 may operate to perform an operation (e.g., a write operation) on shared storage device 300. If the network connection between nodes 12 and 14 is terminated or node 14 becomes unavailable for an unverifiable reason, node 12 may not be able to continue the operation until the reason for unavailability of node 14 is determined. In one embodiment, the reason for unavailability of node 14 is determined based on status information obtained by node monitor 20 and subsequently provided to other nodes.

In certain embodiments, node monitor 20 may store the status information in a status database that is commonly available to a plurality of nodes in the cluster. For example, node 12 may access the status database to determine the reason for unavailability of node 14. If the status database includes information to indicate that the computing device represented by node 14 is disable, then node 12 may continue with its operation, if quorum requirement for the cluster is satisfied. Otherwise, if the status database does not include any definitive status information for node 14, node 12 may not continue its operation on shared storage device 300, if the quorum requirement for the cluster is not satisfied.

In some embodiments, a quorum requirement may be adjusted to allow nodes in a cluster to continue to operate, even if the loss in communication results in creation of a partition that does not include the minimum number of active nodes for the purpose of meeting the quorum. In an exemplary embodiment, system software 102 is implemented to determine whether the quorum requirement is met (S340) after it is determined that a node has been removed from the cluster.

For example, after a node is removed from the cluster, the number of remaining active nodes in the cluster may fall under the minimum number of active nodes needed for the quorum requirement to be met. If so, system software 102 determines whether the removal was due to the physical removal of a computing system or the computing system being powered off, for example.

If it is determined that the removal of the computing system is inconsequential to the sound operation of the cluster, then the minimum threshold required for meeting the quorum is adjusted (i.e., reduced) so that the cluster can continue to operate with a smaller number of active nodes (S350), otherwise human intervention may be necessary to correct the problem.

Accordingly, the quorum requirements can be adjusted so that the cluster can continue to operate without need for human interaction or the cluster being shut down for not having the minimum number of nodes. More particularly, once it is determined that the removal of a node from the cluster does not create the possibility of a conflict or corruption of shared resources, and that is does not otherwise jeopardize the operation of the other computing systems in the cluster then the quorum requirement may be reduced.

It is noteworthy that the above procedures and the respective operations can be performed in any order or in parallel, regardless of numeral references associated therewith. In different embodiments, the invention can be implemented either entirely in the form of hardware or entirely in the form of software, or a combination of both hardware and software elements. For example, node monitor 20 or nodes 12, 14 and 16 may comprise a controlled computing system environment that can be presented largely in terms of hardware components and software code executed to perform processes that achieve the results contemplated by the system of the present invention.

In different embodiments, the invention can be implemented either entirely in the form of hardware or entirely in the form of software, or a combination of both hardware and software elements. For example, nodes 12-16, node monitor 20 and system software 102 may comprise a controlled computing system environment that can be presented largely in terms of hardware components and software code executed to perform processes that achieve the results contemplated by the system of the present invention.

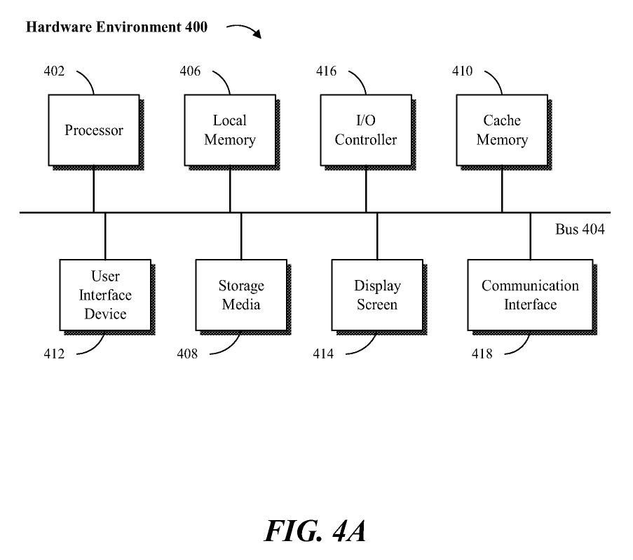

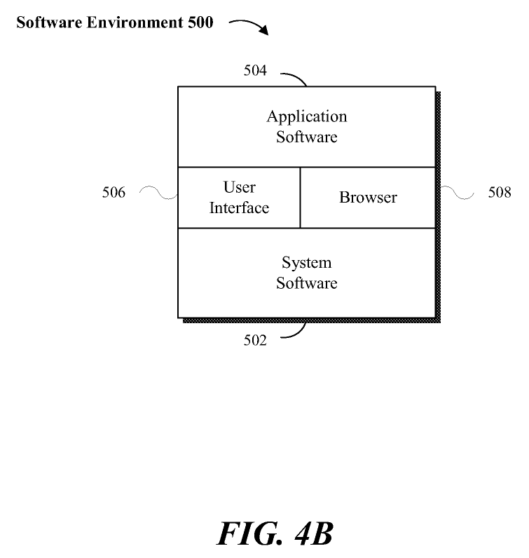

Referring to FIGS. 4A and 4B, a computing system environment in accordance with an exemplary embodiment is composed of a hardware environment 400 and a software environment 500. The hardware environment 400 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 500 is divided into two major classes comprising system software 502 and application software 504. System software 502 comprises control programs, such as the operating system (OS) and information management systems that instruct the hardware how to function and process information.

In one embodiment, system software 102 may be implemented as system software 502 or application software 504 executed on one or more hardware environments to manage removal and addition of nodes in network 40. Application software 504 may comprise but is not limited to program code, data structures, firmware, resident software, microcode or any other form of information or routine that may be read, analyzed or executed by a microcontroller.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital videodisk (DVD).

Referring to FIG. 4A, an embodiment of the system software 502 and application software 504 can be implemented as computer software in the form of computer readable code executed on a data processing system such as hardware environment 400 that comprises a processor 402 coupled to one or more computer readable media or memory elements by way of a system bus 404. The computer readable media or the memory elements, for example, can comprise local memory 406, storage media 408, and cache memory 410. Processor 402 loads executable code from storage media 408 to local memory 406. Cache memory 410 provides temporary storage to reduce the number of times code is loaded from storage media 408 for execution.

A user interface device 412 (e.g., keyboard, pointing device, etc.) and a display screen 414 can be coupled to the computing system either directly or through an intervening I/O controller 416, for example. A communication interface unit 418, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 400 may not include all the above components, or may comprise other components for additional functionality or utility. For example, hardware environment 400 may be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In certain embodiments of the system, communication interface 418 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 4B, system software 502 and application software 504 can comprise one or more computer programs that are executed on top of operating system 112 after being loaded from storage media 408 into local memory 406. In a client-server architecture, application software 504 may comprise client software and server software. For example, in one embodiment of the invention, client software is executed on computing systems 110 or 120 and server software is executed on a server system (not shown).

Software environment 500 may also comprise browser software 508 for accessing data available over local or remote computing networks. Further, software environment 500 may comprise a user interface 506 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps may be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

Therefore, it should be understood that the invention can be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

What is claimed is:

1. A method for managing a networked computing environment, the method comprising:
determining a change in status of a first computing system in a network according to status information communicated from the first computing system to a monitor system over a dedicated connection formed between the first computing system and the monitor system,
wherein the dedicated connection is independent of network communication lines connecting the first computing system to other computing systems in the network.

2. The method of claim 1 further comprising providing information about the change in status of the first computing system to a second computing system in the network by way of the node monitor.

3. The method of claim 1, wherein the first computing system is logically represented as a node in a cluster, the method further comprising:
removing a first node associated with the first computing system from the cluster in response to the node monitor indicating that the status of the first computing system is changed from available to unavailable.

4. The method of claim 3 further comprising adding the first node to the cluster in response to the node monitor indicating that the status of the first computing system is changed from unavailable to available.

5. The method of claim 3, wherein continued operation of a second computing system in the network depends on a first value defining a minimum number of active nodes in the cluster, the method further comprising:
adjusting the first value to allow the second computing system to continue to operate in response to determining that removal of the first node from the cluster results in the number of available nodes falling below the first value.

6. The method of claim 3, wherein the monitor system detects that the first computing system is unavailable in response to the first computing system being powered off.

7. The method of claim 3, wherein the monitor system detects that the first computing system is unavailable in response to the first computing system being disconnected from the network.

8. The method of claim 3, wherein the monitor system detects that the first computing system is unavailable, in response to the first computing system being non-responsive.

9. The method of claim 3, wherein a plurality of nodes in the cluster are configured to collectively operate as a single and unified resource, and wherein collective operation of the nodes depends on a first value defining a minimum number of available nodes in the cluster, the method further comprising:
adjusting the first value to allow for the collective operation of the plurality of nodes, in response to determining that removal of the first node from the cluster results in the number of available nodes falling below the first value.

10. The method of claim 1, wherein the dedicated connection between the node monitor and the first computing system in the network is provided by way of a common chassis to which a plurality of computing systems in the network connect.

11. A system for managing a networked computing environment, the system comprising:
logic code for determining a change in status of a first computing system in a network according to status information communicated from the first computing system to a monitor system over a dedicated connection formed between the first computing system and the monitor system,
wherein the dedicated connection is independent of network communication lines connecting the first computing system to other computing systems in the network.

12. The system of claim 11 further comprising logic code for providing information about the change in status of the first computing system to a second computing system in the network by way of the node monitor.

13. The system of claim 11, wherein the first computing system is logically represented as a node in a cluster, the system further comprising:
logic code for removing a first node associated with the first computing system from the cluster, in response to the node monitor indicating that the status of the first computing system is changed from available to unavailable.

14. The system of claim 13 further comprising adding the first node to the cluster, in response to the node monitor indicating that the status of the first computing system is changed from unavailable to available.

15. The system of claim 13, wherein continued operation of a second computing system in the network depends on a first value defining a minimum number of active nodes in the cluster, the system further comprising:
logic code for adjusting the first value to allow the second computing system to continue to operate, in response to determining that removal of the first node from the cluster results in the number of available nodes falling below the first value.

16. The system of claim 13, wherein the monitor system detects that the first computing system is unavailable, in response to the first computing system being powered off.

17. The system of claim 13, wherein the monitor system detects that the first computing system is unavailable, in response to the first computing system being disconnected from the network.

18. The system of claim 13, wherein the monitor system detects that the first computing system is unavailable, in response to the first computing system being non-responsive.

19. The system of claim 13, wherein a plurality of nodes in the cluster are configured to collectively operate as a single and unified resource, and wherein collective operation of the nodes depends on a first value defining a minimum number of available nodes in the cluster, the system further comprising:
logic code for adjusting the first value to allow for the collective operation of the plurality of nodes, in response to determining that removal of the first node from the cluster results in the number of available nodes falling below the first value.

20. A computer program product comprising a computer useable medium having a computer readable program, wherein the computer readable program is executed on a computer to cause the computer to:
determine a change in status of a first computing system in a network according to status information communicated from the first computing system to a monitor system over a dedicated connection formed between the first computing system and the monitor system,
wherein the dedicated connection is independent of network communication lines connecting the first computing system to other computing systems in the network.
